(19) United States
(12) Patent Application Publication
(10) Pub. No.: US 2012/0218498 A1
(43) Pub. Date: Aug. 30, 2012

(54) OPTICALLY CONTROLLED DEFORMABLE REFLECTIVE/REFRACTIVE ASSEMBLY WITH PHOTOCONDUCTIVE SUBSTRATE

(75) Inventors: Stefano Bonora, Ponte San Nicolo' (IT); Stefania Residori, Verona (IT); Umberto Bortolozzo, Vigonza (IT)

(73) Assignee: Consiglio Nazionale Delle Ricerche, Roma (IT)

(21) Appl. No.: 13/504,759

(22) PCT Filed: Oct. 30, 2009
(86) PCT No.: PCT/IB09/54829

§ 371 Date: Apr. 27, 2012

(51) Int. Cl. G02F 1/1335; F21V 7/00; G02F 1/29; F21V 5/00

(52) U.S. Cl. 349/113; 362/278; 359/315; 359/318

(57) ABSTRACT

An optically controlled deformable reflective/refractive assembly includes a deformable membrane structure (10) having a reflecting/refractive, electrically conductive surface (10′), which is associated with a rigid photoconductive substrate (14) having an electrically conductive layer (14′) on one side. An electric biasing arrangement applies a potential difference (V₀) across the membrane structure (10). A controlling light source (20) illuminates the photoconductive substrate (14) in correspondence of an active region, wherein the light source is arranged for selectively illuminating the substrate (14) by emitting at least an optical beam (B) adapted to generate in an area of the substrate (14) a local electrical charge density proportional to the spatial light intensity of the beam (B) and responsible for a local deformation of the membrane structure (10).

The present invention concerns the field of optical processing, and particularly an adaptive deformable optical reflective/refractive element. Specifically, the invention relates to a deformable reflective/refractive assembly according to the preamble of claim 1.

An optical reflective/refractive element is either a mirror or a lens depending on the properties of the surface (reflective or refractive) on which the optical radiation to be processed impinges.

Deformable mirrors are key components in many optical processing systems and have a broad range of applications in optical processing science, including adaptive optics, wave-front correction and time spatial beam-shaping. Recent advances in adaptive optics have made the realization of deformable mirrors a subject of intense research. Following the local deformation of the mirror surface, deformable mirrors induce spatially controlled phase change on the reflected beam, thus acting as spatial light modulators.

As an example, deformable mirrors used in adaptive optical systems allow measuring the distortion of an incident wave-front and accomplishing the correction of said distortion and the consequent shaping of the reflected beam. Such a correction is necessary in astrophysics and astronomy, since the light beams from celestial bodies undergo a number of refractions (deviations from the linear path) in the atmosphere, due to turbulence, wind, pressure and/or temperature variations, and therefore they have to be corrected with a view to displaying the actual clear image of the light source.

Several schemes for optoelectronic deformable mirrors have been proposed up to now, based either on independently actuated juxtaposed rigid sections made of piezoelectric material, or on flexible large-area reflective membranes. The rigid sections or the elemental areas of the membrane act as independent reflective elements, and are driven by respective independent actuators, in order to carry out a local mirror deformation adapted to achieve a desired correction of the locally incident wave-front.

Current implementations of deformable mirrors based on electrically driven active segments, or actuators, each individually addressed in such a way that the whole mirror deformation fits the desired correction to be imposed on the incoming wave-front, even though successful for some specific applications, especially in astrophysics and astronomy, present indeed several drawbacks, like the complexity of the electronic circuitry driving each pixel individually, the discretization of the deformation and the limited spatial resolution of the reflected images.

With respect to rigid actuator sectioned mirrors, optoelectronics membrane mirrors offer the advantage of a single reflecting layer, with the voltage applied onto different sections of the membrane through a pad array of actuators.

Prior art reports the realization of electrostatic membrane deformable mirrors where the electrostatic force is applied by the use of a finite number of electrodes (20 to 40 in the most popular embodiments) positioned close to the membrane. This system is economically convenient, but the electronic complexity is high. In fact in this device each channel is composed by an independent high voltage amplifier (0-300V).

These devices need the cabling of a number of amplifying lines, one for each actuated segment, therefore leading to a complex and bulky driver assembly, including a number of cables and other high voltage components, which are expensive. In addition, the bulkiness of the actuators and their positioning does not allow flexibility of the possible deformations.

Only recently, a photoconductive optically controlled spatial light modulator has been realized for near infrared applications, where the addressing is on a single photoconductive substrate. This arrangement is disclosed in J. Khoury, A. Drehman, C. L. Woods, B. Haji-Saeed, S. K. Sengupta, W. Goodhue, J. Kierstead, “Optically driven micro-electromechanical-system deformable mirror under high frequency AC bias”, Opt Lett 31, 808-10 (2006). A 2 μm thick aluminized Mylar membrane is suspended over a 250 μm semi-insulating photoconductive substrate, such as GaAs or InP. A grid of 5 μm thick insulating material, such as a photo-lithographically patterned photo-resist, is used to support the suspended membrane, and an IR-transparent conducting ZnO electrode layer is deposited on the back side of the substrate. A dc or a very high-frequency ac bias voltage is applied between the membrane and the transparent ZnO back electrode. The mechanism behind the operation of this device is as follows: illumination of the back of the device increases the conductivity of the photoconductive layer, which leads to a redistribution of the effective field between the suspended membrane and the front side of the semiconductor. This increases the deflection of the membrane in the area of illumination. If the ac modulation frequency is much higher than the resonant frequency of the membrane, the deflection is proportional to the square of the average of the applied voltages across the membrane and substrate.

Disadvantageously, the deformable mirror proposed by Khoury et al. is still pixellated and a continuous deformation of the membrane for an improved resolution in the correction of the incident beams is not achievable.

This device is limited to the generation of spherical deformations of small size, which are of no use in applications where the generation of arbitrary shapes are necessary, such as astronomy, microscopy, free space communications, lasers, ophthalmology.

Specifically, the authors report a device with pixels of 1 mm and 7mm actuated by uniform light intensity, which allows only to reproduce a spherical deformation (solution of the Poisson equation under the application of a uniform pressure) on a single binary-actuated pixel (only two positions are possible). Moreover, the fabrication of small structures (diameters 1-7mm) makes the optical quality (flatness) of the device critically dependent on the quality of the bounding of the membrane to the frame. Figures in the paper illustrate how the device lacks mechanical quality to match the typical requirements for optical setups and applications.

On the other side, adaptive optics devices can be formed by refractive variable elements. Recently some technologies have become commercially available with a lot of high volumes applications (for example, refer to Duncan Graham-Rowe, Liquid lenses make a splash, Nature Photonics, 2006).

The technology of deformable lenses is mainly based on electro-wetting and liquid crystals. Electro-wetting has become available quite recently as commercial device exploiting three basic schemes. The reference above illustrates very well the differences between the three main commercially available technologies. These devices find an extremely wide use, because of their compactness and low voltage operation, in mobile phones, micro cameras, photo cameras, etc.

In one embodiment the lens is formed by two immiscible liquids, one conductive and the other insulating, respectively. Applying an electric field changes the liquid shape and then the optical properties. A second embodiment exploits the change of the amount of volume of a liquid in a chamber by means of a piezoelectric pump.

Liquid crystal devices are interesting as well, but they find much limited application because they work in polarized light (see: A. F. Naumov et al., Multichannel liquid-crystal-based wave-front corrector with modal influence functions, Optics Letters, Vol. 23, No. 19, Oct. 1, 1998), and/or because of their pixilated nature.

All these embodiments of deformable lens are limited to a clear aperture of a few millimeters, since they are not scalable in size because of gravity, which would deform the lens creating a lens quality degradation. Moreover, they can act just as variable focal length correctors, but no correction of higher order aberration is possible.

The aim of the present invention is to overcome the drawbacks of the prior art, and in particular to provide an all-optical controllable adaptive reflective/refractive assembly, formed by a deformable reflective/refractive membrane structure, operating without any pixellization of the optical beam to be processed, i.e. capable of undergoing a continuous and any desired local deformation of the membrane, and thus affording a greater spatial resolution than as achieved with the prior art.

It is a further object of the invention to provide a deformable reflective/refractive assembly capable of being dynamically controlled in a simple way, while preserving the mechanical stability of the assembly.

Yet another object of the invention is to make available a deformable reflective/refractive assembly capable of providing a large induced phase change of the reflected or refracted beam, suitable for applications requiring large aberration corrections.

According to the invention, the above objects are achieved by an optically controlled deformable reflective/refractive assembly having the features claimed in claim 1.

Particular embodiments are the subject of the dependent claims, whose content is to be considered as an integral or integrating part of this description.

In summary, the optically controlled deformable reflective/refractive assembly of the invention is formed by a reflecting/refractive deformable membrane structure associated with a substrate of a photorefractive and photoconductive material, at a predetermined distance therefrom. The membrane structure is deformed by virtue of an electrostatic, piezoelectric or electrostrictive force, depending on an established electric charge density which is locally modulated by an illuminator.

In a currently preferred embodiment of a deformable mirror, the membrane structure is a reflecting, metalized, elastically deformable membrane supported on the substrate by interposition of a perimeter spacer acting as, or backing a rigid frame for the membrane. The photoconductive material and the membrane act as the plates of a capacitor. In the operating condition, a biasing voltage is applied across the photoconductor-membrane association. In absence of illumination the voltage drops across the photoconductor, when illuminated the conductivity increases and the voltage drops across the membrane, whereby the membrane is deformed by electrostatic force.

In another embodiment the membrane structure includes a piezoelectric/electrostrictive plate associated in contact with the substrate, and having a front side coupled to said reflecting surface, either directly or by means of a passive layer. A potential difference acting on the piezoelectric/electrostrictive plate is established across two electrodes arranged on opposite sides of the plate, on the front side of the plate and the photoconductive substrate, respectively. In the operating condition, when the substrate is selectively illuminated, the conductivity of the photoconductor locally changes inducing local radial expansion or contraction of the plate by piezoelectric or electrostrictive effect, thereby hollowing its front side out or bulging it, and inducing a curvature in the substrate.

In a further embodiment, the metalized membrane is made of a dielectric elastomer or any electro-active polymer, and is associated in contact with the photoconductive substrate. A potential difference acting on the electro-active membrane is established across the photoconductor-membrane association. In the operating condition, when the substrate is selectively illuminated, the conductivity of the photoconductor locally changes inducing local radial expansion or contraction of the electro-active material by virtue of the electromechanical transduction properties of the elastomeric material, thereby hollowing its front side out or bulging it, and inducing a curvature in the substrate.

The mirror assembly includes a preferably collimated light source arranged for selectively illuminating the photoconductive substrate so as to address the deformation in the membrane. Acting as a photoconductor, the photorefractive crystal allows writing local deformations on the membrane by means of local illuminations, whose intensity distribution may be controlled directly by the collimated light source or any light modulator interposed between the source and the mirror.

When a punctual light beam is shone onto the substrate its impedance locally decreases due to its photoconductive properties, thus leading to an increased local capacitive or piezoelectric effect and a subsequent deformation of the membrane that follows the local capacitance change, the local piezoelectric/electrostrictive effect respectively.

In the electrostatic embodiment, the free space defined between the suspended membrane and the substrate, and delimited by the perimeter spacer, receives the membrane in the deformed condition, and within it any arbitrary continuous pattern of deformation of the membrane is advantageously allowed. The useful area of the membrane in correspondence to the photoconductive substrate and capable of undergoing deformation for generating arbitrary shapes, called active region, is limited by the boundary of the membrane where it is supported on a rigid frame.

The response of the membrane is described by the Poisson equation for tensioned membranes with proper boundary conditions. The membrane response can be seen as a low pass filter. So the result is that applying an electrostatic pressure on a point of infinitesimal size of the membrane, the membrane deformation has a finite diameter. For the usual geometrical parameters (negligible membrane thickness) the impulse response deformation has a diameter FWHM of about 1 mm.

In the currently preferred embodiment, the membrane is glued to a ring frame mechanically worked to optical precision (better than λ/10, where λ is the optical wavelength of the illuminating source), and the active region diameter is 0.6 times the membrane diameter.

In the piezoelectric or elastomeric embodiment, where the material having electromechanical transducer properties contacts the photoconductive substrate and is not suspended over it, the degree of deformation of the reflecting surface, or its passive supporting layer, depends on the degree of local extension/contraction of the active material, thereby advantageously still allowing any arbitrary continuous pattern of deformation. The useful area of the reflective surface capable of undergoing deformation for generating arbitrary shapes, called active region, is limited by the boundary of the electro-active material on which it is supported.

According to a further aspect of the invention, the intensity distribution of the local illumination to the membrane is modulated by a liquid crystal screen or like electronically driven intensity modulator, thus achieving a degree of freedom and resolution in controlling the mirror deformations which are unparalleled in the prior art. In addition, commercially available LCDs are a cheap technology compared with other electronic signal conditioning devices, such as prior art high voltage amplifiers and related bus cables for driving piezoelectric actuators.

Thanks to this mechanism, a local and dynamical control of the mirror is performed by changing the illumination on the photoconductor, thus guaranteeing the mechanical stability of the mirror assembly. A local response of the membrane is achievable at any arbitrary position within the active region of the membrane, thus allowing an enhanced spatial resolution as well as a larger induced phase change of the reflected beam.

Whereas the preceding considerations have been made referring to a deformable mirror, the same applies to a lens embodiment, based on a refractive deformable membrane instead of a reflective one. Thus, in the following, any teaching relating to a deformable mirror should be construed by a skilled person as generally referred to an optical reflecting or refractive element.

The inventive reflecting/refractive assembly is a cost-effective and compact device, with a single driving power supply and a single cable for communication with a controller.

Further characteristics and advantages will be disclosed in detail in the following description, given as a non-limitative example, referring to the appended drawings, in which:

FIG. 1 is a schematic diagram representing an optically-controlled deformable mirror assembly according to the invention;

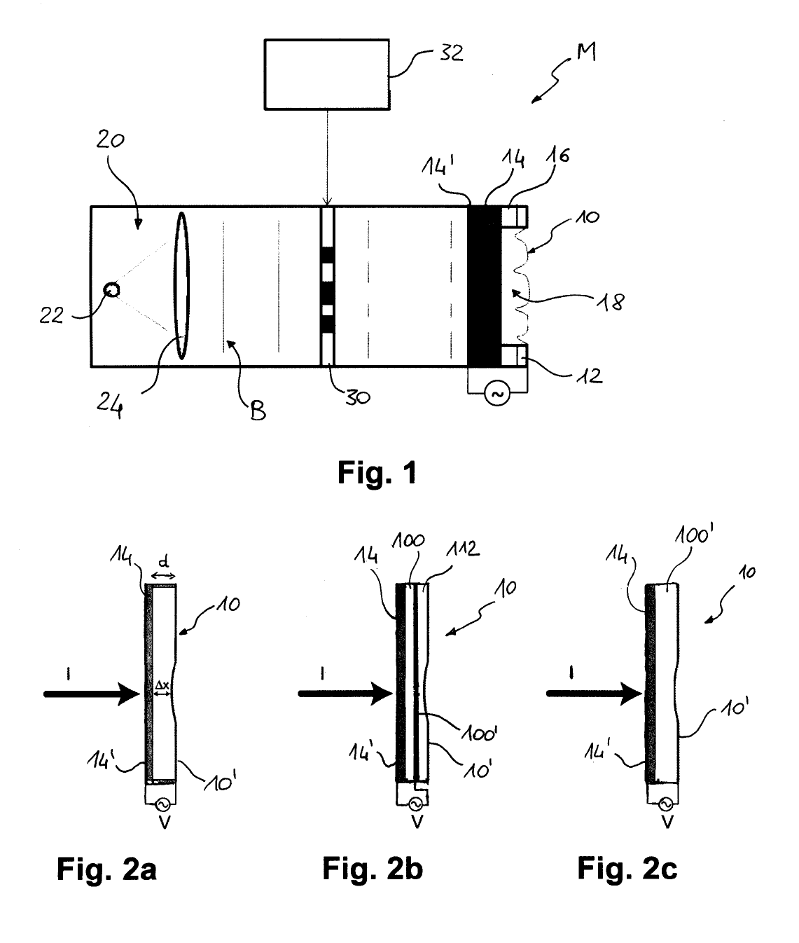

FIGS. 2a-2c are schematic diagrams showing the configurations and operating conditions of exemplary deformable mirrors according to different embodiments of the invention;

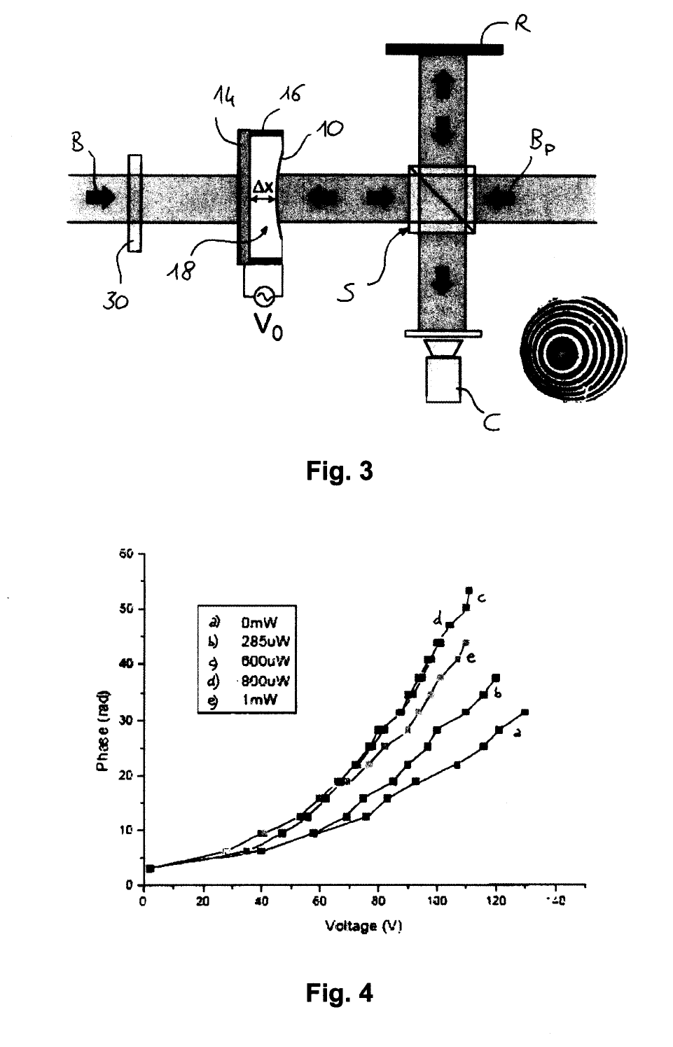

FIG. 3 is a schematic diagram representing an interferometric setup for the measurement of the mirror deformation;

FIGS. 4 is a graph showing the phase change of the reflected beam as a function of the applied voltage;

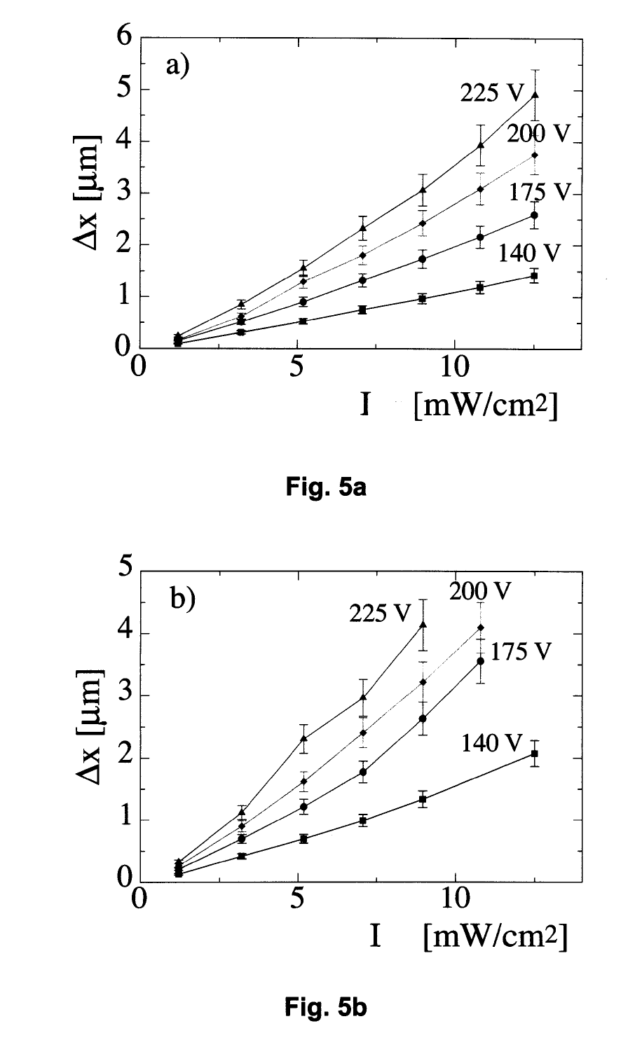

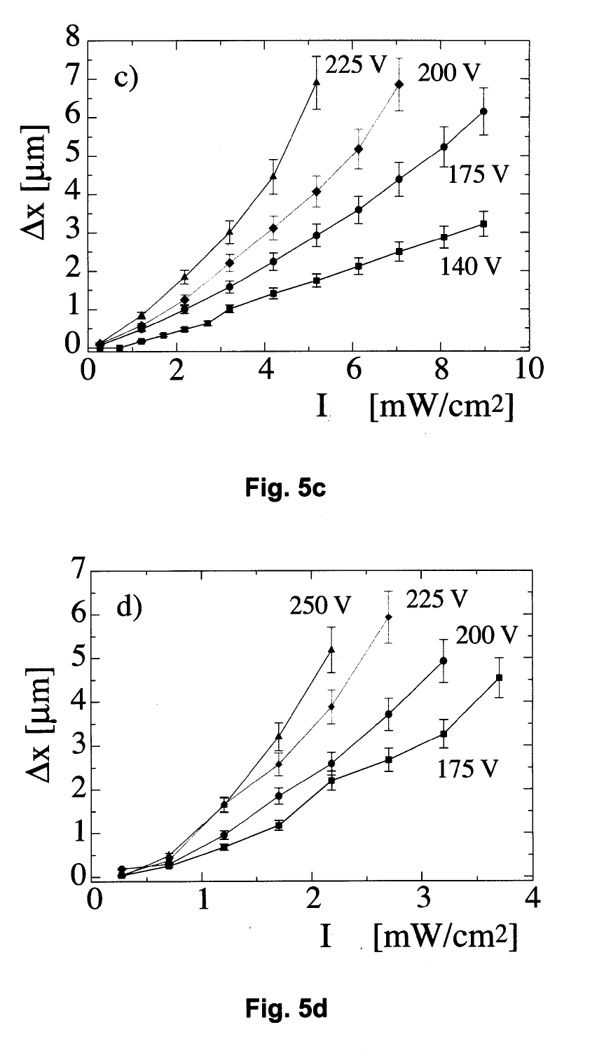

FIGS. 5a, 5b, 5c and 5d are graphs showing the phase change of the reflected beam as a function of the light intensity on the photoconductor, for different values of the voltage applied to the mirror and of the frequency;

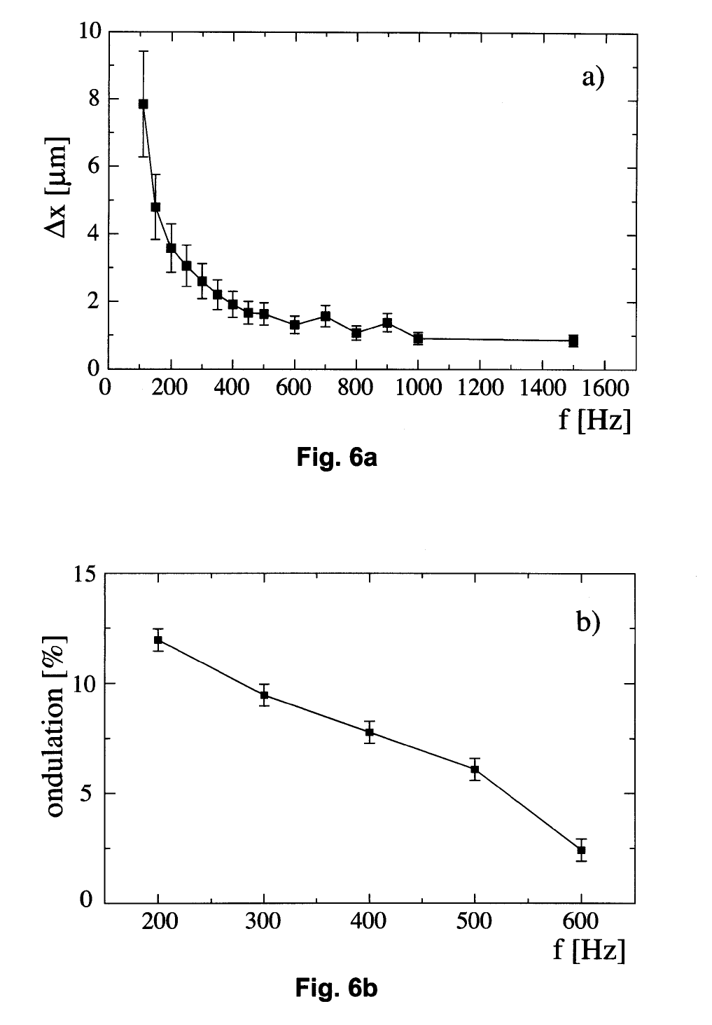

FIGS. 6a and 6b are graphs showing, respectively, the maximum membrane displacement and the relative maximum oscillation amplitude as a function of the frequency of the voltage applied to the mirror;

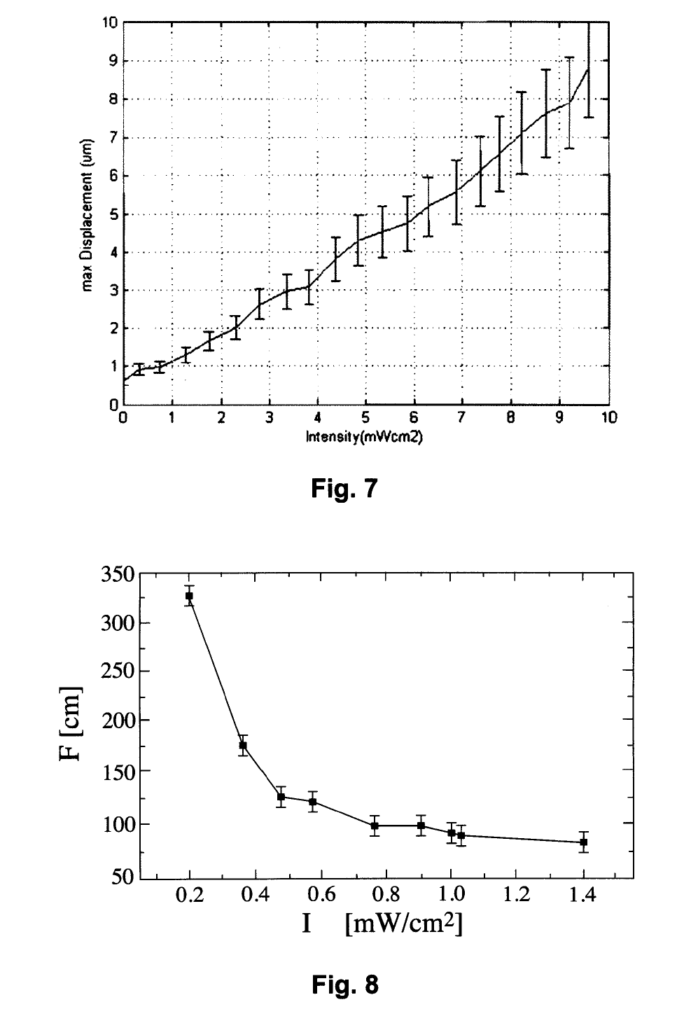

FIG. 7 is a graph showing the maximum membrane displacement as a function of the uniform light intensity addressing the photoconductor substrate;

FIG. 8 is a graph showing the measured focal length of the reflected beam as a function of the intensity of the addressing beam;

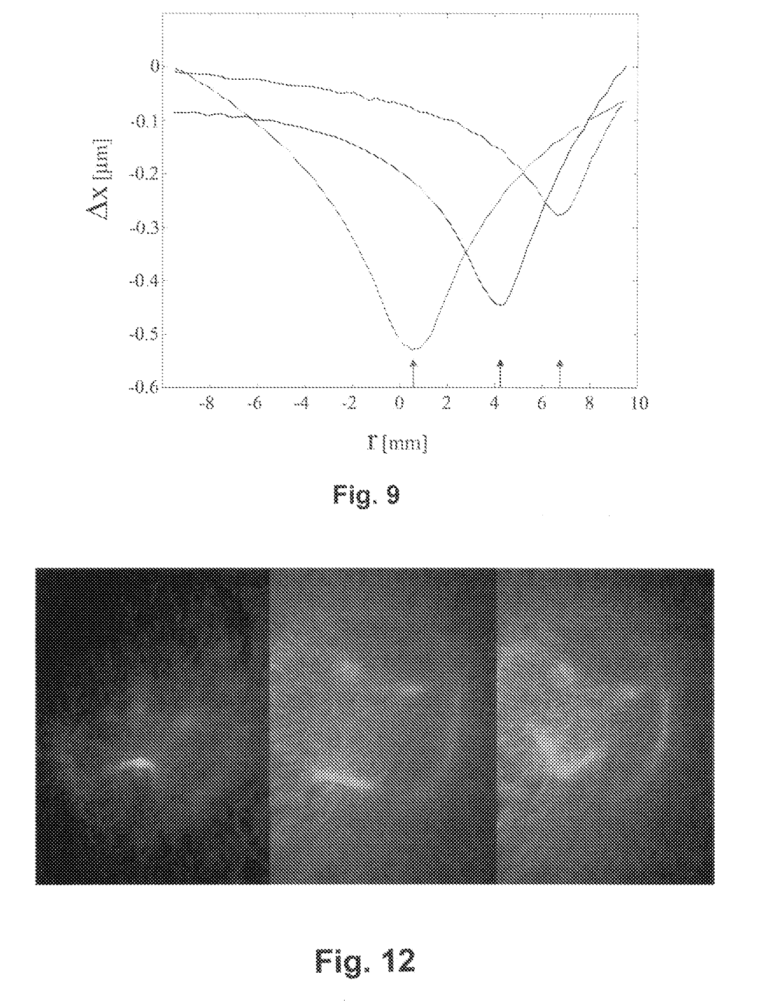

FIG. 9 is a graph showing the membrane deformation as a response to a local optical pulse at different positions on the membrane;

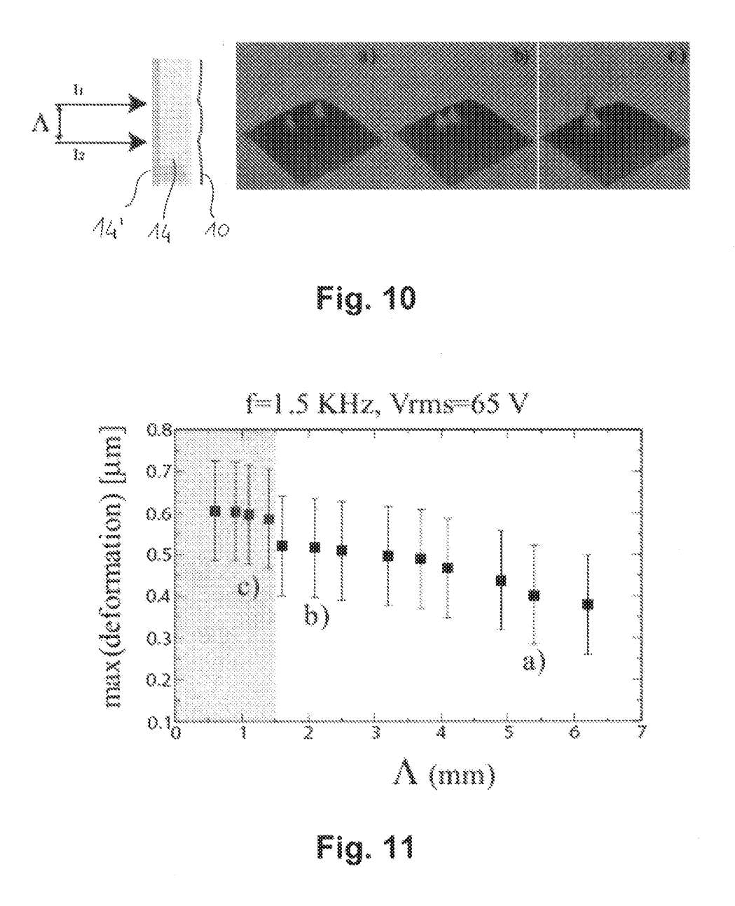

FIGS. 10 and 11 are images of a simulation and a graph, respectively, showing the dependence of the maximum membrane deformation as a function of the distance between the two addressing spots; and

FIG. 12 is a collection of snapshots showing the beam reflected by the mirror when this is addressed by corresponding images projected through a LCD.

FIG. 1 shows a currently preferred embodiment of an optically-controlled deformable mirror assembly M according to the invention, comprising a metalized, elastically deformable membrane 10, supported peripherally by a rigid frame 12, and associated with a photoconductive substrate 14 carrying a surface back-electrode 14′, from which it is separated by means of one or more peripheral spacers 16 arranged in proximity of the edge of the membrane, so as to form a free space or gap 18 in correspondence to the whole active region of the membrane, i.e. the region of illumination of the substrate and consequent deformation of the membrane.

At the back of the photoconductor substrate a controlling light source is arranged, generally referred to with 20, for example comprising a point-like source 22, such as a LED or laser diode, and associated collimating optics 24, for generating a controlling light beam B. Interposed along the path of the optical beam from the source to the photoconductive substrate, or in contact with the latter, is a screen 30 for the spatial modulation of the light intensity, preferably an LCD screen driven by a respective control unit 32, such as a personal computer connected through a standard USB port, adapted to switch the state of the single pixels of the screen. A feedback loop could be implemented by driving the screen with a signal calculated as a function of the spatial features of the reflected beam. The setup will require a computer interfaced camera that records the reflected beam as well as a dedicated software that treats the acquired images and calculates the feedback signal that has to be sent to the LCD. Moreover, an all-optical feedback could also be realized by sending back to the photoconductive side of the mirror the beam reflected by the membrane. By designing the optical loop in a proper way, different image operations could be implemented, such as, for example, filtering in the Fourier plane, thus allowing the selective suppression of unwanted spatial frequencies.

The metallization or electrically conductive layer of the membrane 10 and the electrode deposited on the photoconductive substrate 14 form the plates of a capacitor, across which a voltage difference may be applied. This has the undesired consequence of attracting the deformable membrane towards the substrate due to a capacitive effect. An operation of the mirror based on the continuous frequency control of the biasing voltage is even possible. By introducing a continuous frequency control, the mirror could be driven in such a way to produce a swept of the deformation, hence, providing a variable phase retardation that follows the electrical frequency modulations. In this configuration the mirror will act as a converter from electrical to optical modulations.

The light beam B irradiated by the source 22 and collimated so as to uniformly illuminate the substrate at the side opposite the reflecting membrane, is made to impinge on the photoconductive substrate for generating therein corresponding electrical charges. When the substrate is completely and uniformly illuminated, the membrane undergoes the greatest deformation assuming a paraboloid shape. Local deformations on the membrane are achieved by spatial modulation of the intensity of the control optical beam B. An operation of the mirror based on the continuous control over time of the uniform intensity of the addressing light beam is also possible by employing the same feedback setups described above.

An exemplary sample mirror has been fabricated as in FIG. 2a and an interferometric setup has been implemented for the measurement of the membrane deformation, as depicted in FIG. 3.

The photoconductive substrate 14 is a photorefractive Bi₁₂SiO₂₀ (BSO) crystal cut in the form of a thin disk, 1 mm thickness and 35 mm diameter, and on one side coated with a transparent electrically conductive layer (electrode) 14′ of Indium-Tin-Oxide (ITO). The BSO is transparent in the visible range and has its maximum photoconductive response in the interval between 450 and 550 nm. The BSO substrate is prepared by washing in ultrasound bath and drying with compressed air. Other photoconductive crystals may be used which are sensitive in the near IR, for example doped BaTiO₃.

The membrane 10 is a nitrocellulose layer, 5 μm thickness, metalized by an Ag coating 10′, or otherwise coated with an electrically conductive layer. It is mounted on a rigid Aluminum ring 12, which has also a diameter of 25.4 mm, by means of a photo-polymerizing glue.

Mylar spacers 16 are inserted between the uncoated side of the BSO and the ring frame supporting the membrane, in order to provide a gap of a few tens of microns. The membrane is stretched so as to make it flat and its distance from the substrate is chosen at a value between 20 and 200 μm, and preferably between 50 and 120 μm. Different mirrors have been built, with gaps of d=20 and 50 μm, as good compromises between the maximum allowable deformation before the membrane snaps down on the photoconductive substrate and the optimization of the capacitive effect.

An ac bias voltage V₀ is applied across the mirror. The BSO substrate acts as a photoconductor and modulates the voltage across the gap as a function of the impinging light intensity I, addressed by the backlighting source 20. When a light beam is shone onto the BSO, its impedance locally decreases, thus leading to an increased local capacitive effect and a subsequent deformation of the membrane. The impedance of the BSO decreases when the intensity of the incident illumination I increases. When the bias voltage V₀ increases, the capacitive effect attracts the membrane towards the BSO substrate, hence, when the BSO side is uniformly illuminated, a large deformation is induced in the form of a paraboloid. Once the membrane has reached an equilibrium position, further deformations can be superimposed by local illuminations.

It should be noted that other types of membrane could be used, such as elastomers or electroactive polymers or piezoelectric/electrostrictive materials, that can allow even larger deformations as well as better spatial resolution.

Transparent elastomers or electro active polimers could also be employed, thus allowing the operation of the device in transmission instead of reflection, without thereby departing from the scope of the invention. In this case the ground electrode should be realized using a transparent conductor film such as Indium-Tin-Oxide or Zinc-Oxide or very thin metal layers. As for the photoconductive substrate, this could be realized by other types of photorefractive crystals, provided they give a good photoconductive response in the range of visible wavelengths. Devices working in the near infrared (λ from 850 nm to 1.5 μm) could also be realized by using semiconductor crystal plates (for example semiconductor wafers such as silicon, gallium arsenide, etc wafers are good candidates thanks to their photoconductive properties). Though a preferred description has been given of a deformable mirror, the invention should be construed as also applicable to deformable lenses, or in a more general definition to deformable catoptrical, dioptrical or catadioptrical reflective/refractive elements.

FIGS. 2b and 2c depict embodiments where other types of membrane are used and the deformation of the membrane structure is based on the piezoelectric effect or the electromechanical transduction effect in elastomeric materials as an alternative to the electrostatic effect. In the figures, identical or functionally analogous elements or components are identified with the same reference numerals.

Referring to FIG. 2b, the deformable membrane structure 10 includes a piezoelectric plate 100 deposited on the photoconductor substrate 14, with a front side 100′ coupled to the reflecting surface 10′ by means of a passive support layer 112, e.g. made of copper or glass. An ac bias voltage V₀ is applied between the front side 100′ of the piezoelectric plate and the metallization layer (back electrode) 14′ of the photoconductive substrate 14. The potential difference generally applied across the plate 100 undesirably causes said plate to radially expand or contract, thereby hollowing or bulging the passive support layer 112 and/or the reflecting surface in the active region. Local illumination of the photoconductive substrate 14 changes the conductivity of the photoconductor locally, thereby increasing the piezoelectric effect and inducing local radial expansion or contraction of the plate, thus superimposing a local deformation of the surface to the equilibrium position reached by application of the biasing voltage.

Referring to FIG. 2c, the deformable membrane structure 10 includes an elastomeric membrane 100′ with a metallization or an electrically conductive layer 10′ acting as the reflective/refractive surface, deposited on the photoconductor substrate 14. An ac bias voltage V₀ is applied between the reflective metalized surface 10′ and the metallization layer (back electrode) 14′ of the photoconductive substrate 14. The potential difference generally applied across the elastomeric membrane 100′ undesirably causes it to radially expand or contract, thereby hollowing or bulging the reflecting surface 10′ in the active region. Local illumination of the photoconductive substrate 14 changes the conductivity of the photoconductor locally, thereby further inducing local radial expansion or contraction of the electro-active material, thus superimposing a local deformation of the surface to the equilibrium position reached by application of the biasing voltage.

Reverting to the preferred embodiment of FIG. 2a, precise deformation measurements have been performed, based on a modified Michelson interferometer, as shown in FIG. 3.

An input probe laser beam B_{P}λ=474 nm, is expanded and collimated, the beam diameter being 1 cm. The beam is sent onto the membrane side of the mirror, is reflected by the metallic coating of the membrane, thus acquiring a phase delay Ay according to the illumination conditions on the BSO side, and is made to interfere with a reference plane wave. The setup is based on the scheme of a Michelson interferometer: the probe and the reference wave are derived from the same input beam and separated through a beam splitter S. While the reference travels to a reflecting plane mirror R and then to a CCD camera C, the probe travels forth to the membrane and then back to the beam splitter and the camera. The reflected probe beam and the reference wave combine at the camera, where they produce an interference fringe pattern. When the voltage V₀ is applied across the device, the membrane deformation (herein identified by the residual gap Δx in the free space 18 behind the membrane itself) is directly seen as a radial displacement of the fringe pattern. A typical interferogram showing the membrane deformation is displayed in the bottom right corner of FIG. 3.

By recording the fringe displacement, the phase change of the reflected beam has been measured for different experimental parameters. From the phase change the maximum membrane deformation has been calculated. The phase change is plotted in FIG. 4 as a function of the applied ac voltage, at a frequency of 40 kHz, and for different levels of illumination I on the photoconductor side of the device. The light beam B illuminating the photo-conductor comes from a second laser, λ=474 nm, and is enlarged up to 25 mm diameter in order to have an uniform intensity on the whole active area of the device.

By performing the same type of interferometric measurements, the voltage has been fixed and the phase change of the reflected beam has been measured as a function of the light intensity I on the photoconductor side of the mirror. The results are plotted in FIGS. 5a-5d for different values of the applied voltage V₀ and different frequency f of the applied voltage. The maximum response is obtained for an applied voltage of 200 V rms and for a light intensity of about 600 mW/cm^{2.} For higher values of the intensity saturation effects come into play and the response is lower.

The maximum membrane deformation, Δx, is plotted in FIG. 6a as a function of the frequency f of the applied ac voltage V₀ (set with an amplitude of 140 V peak-to-peak), and for a uniform illumination of 4.37 mW/cm² intensity on the BSO side. The thickness of the mirror gap is d=50 μm. The frequency of the applied voltage is changed from 50 to 1500 Hz. The light beam B illuminating the photoconductor comes from a blue diode, enlarged and collimated up to 3.5 mm diameter in order to have a uniform intensity on the whole active area of the mirror. The maximum membrane displacement is of the order of ten microns and is obtained for low frequency operation, with low intensity of illumination. At high frequency, the capacitive effect is reduced and consequently the same deformation of the membrane is obtainable with a greater intensity of illumination. The membrane displacement saturates to a maximum value of 1 μm at higher frequencies.

In FIG. 6b it is plotted the maximum relative oscillation amplitude of the membrane under the application of a low frequency voltage. It can be noticed that even at low frequencies the maximum undulation remains under 15 percent. At high frequencies (higher than 600 Hz) the undulation is completely negligible (less than one percent).

For the following operation of the mirror, the working point at f=200 Hz has been chosen. At this frequency the maximum membrane displacement is 3.5 μm and, at the same time, the membrane oscillations are not as important as at low frequency. At f=200 Hz the distortions introduced by the membrane oscillations have been evaluated to be around λ/10.

By performing the same type of interferometric measurements, the voltage amplitude and frequency have been fixed and the phase change of the reflected beam has been measured as a function of the light intensity on the BSO side of the photo-addressed mirror.

The results are plotted in FIG. 7 for an applied voltage V₀ of 140 V peak-to-peak (100 V rms) at a frequency of 200 Hz, while the BSO side is illuminated by an uniform beam of increasing intensity.

The model describing the response of the mirror can be derived by considering that the membrane deformation M(ρ, θ) obeys a Laplace equation M(x,y) can be written as

$${∇}^{2} M ( ρ , θ ) = \frac{{ɛ}_{0}}{2 T} \frac{{V}_{GAP}^{2}}{{d}^{2 }}$$

where ρ and θ are the radial and angular directions, respectively, T is the membrane tension factor and V_{GAP} is the effective voltage drop across the empty gap of the mirror and d is the thickness of the gap.

By approximating the membrane deformation with a parabolic profile with a full rotational symmetry around the center, and by taking the appropriate boundary conditions, we obtain the maximum membrane deflection M(0, θ)≡Δx which occurs at the center, (ρ=0), and is given by

$$Δ x = \frac{{ɛ}_{0}}{32 T} \frac{{a}^{2} {V}_{GAP}^{2}}{{d}^{2}} ,$$

where a is the diameter of the membrane.

By approximating the BSO response with a linear function, we have that V_{GAP}=ΓV₀+αI_{w}, where V₀ is the voltage externally applied to the mirror, F is the dark impedance of the BSO, I_{w} is the intensity of the controlling beam B or write intensity, and a is a phenomenological parameter that can be deduced from the mirror characteristics.

By developing Ax at the first order approximation, we obtain

$$Δ x = \frac{{ɛ}_{0}}{32 T} \frac{{a}^{2} {Γ}^{2} {V}_{0}^{2}}{{d}^{ 2}} ( 1 + 2 \frac{α {I}_{w }}{Γ {V}_{0 }} )$$

The phase delay acquired by the probe beam is

$$Δ ϕ = \frac{2 π}{λ} 2 Δ x$$

which gives a quadratic scaling with V₀ and a linear scaling with I_{w}.

For low intensities I_{w} of the light impinging on the photoconductive substrate, and small applied voltages V₀ the linear dependence of Δx from I_{w} is in agreement with the experimental results. In particular, the linear scaling of Δx with I_{w} is in good agreement with the results reported in FIG. 7. When I_{w} and V₀ increase higher order corrections take into account the deviations from the linear behaviour.

For V₀=140 V peak-to-peak and f=200 Hz, and no illumination on the BSO side, the membrane deformation is small (less than 1 μm) and a large dynamic range can be exploited for the photo-addressing.

In a further test, a localized light spot has been sent on the BSO side of the mirror, and correspondingly the reflected beam was focused at a distance that changes with the intensity of the addressing beam. When a local illumination is sent onto the BSO side (beam diameter 2 mm), the mirror correspondingly focuses the reflected beam in a sharp spot. The focal length changes with the intensity of the addressing beam. In FIG. 8 the focal distance F as a function of the addressing intensity is reported, for V₀=210 V peak-to-peak, and f=200 Hz.

The spatial impulse response has been measured by addressing on the photoconductive substrate a laser beam B with a diameter of 300 μm and intensity I=1 mW/cm^{2,} and recording the deformation induced on the membrane. The voltage applied to the membrane is V₀=165 V peak-to-peak, and the frequency f=400 Hz. The results are shown in FIG. 9, plotting three deformation profiles corresponding to three different positions of the controlling beam with respect to the centre of the active region of the membrane, at r=0.05, 4 and 6 mm. At the boundary of the membrane a greater rigidity of the membrane itself may be appreciated, whereby the deformation is smaller.

To measure the spatial resolution of the device, experiments have been performed by sending two localized addressing beams I₁ and I₂ on the photoconductor, separated by a distance Λ, as depicted in FIG. 10. Each beam has a spot size of 0.6 mm and an intensity of 100 μW/cm^{2.} The voltage applied to the adaptive mirror is V₀=65 V rms, and the frequency 1.5 kHz. By changing the distance A between the two beams I₁, I₂ a sequence of images of the reflected beam has been recorded and the membrane deformation has been reconstructed through the intensity profile of the recorded images. Three typical transverse profiles of the membrane deformation are shown in FIG. 10 (a to c) under the application of two light spots, as the relative distance Λ between the two light spots is decreased from 5.5 to 2.0 and then 1.0 mm.

In FIG. 11 the dependence of the maximum membrane deformation is shown as a function of the distance A between the two addressing spots. When the two addressing beams are approached at 1.0 mm or less, then the two deformations merge together and a single double-amplitude bump is formed on the membrane. This limit fixes the spatial resolution of the optical control on the mirror to 1.0 mm, which is better than usual values for pixellated mirror and could be easily increased by using other types of smoother membrane materials, such as elastomers or piezoelectric materials.

Finally, the performances of the mirror for imaging operations have been tested. Through the LCD screen 30 different images have been projected on the photoconductive side of the mirror. Correspondingly, the intensity distributions of the beam reflected by the membrane of the mirror have been recorded. Three representative instantaneous snapshots are displayed in FIG. 12.

In conclusion, it has been demonstrated that new types of deformable reflective/refractive optical elements, such as mirrors or lenses, can be realized by the association of a metalized deformable membrane with a photorefractive crystal acting as a photoconductor, thus providing all-optical and dynamical control of the membrane deformation.

The assembly design according to the invention advantageously provides mechanical stability and photo-addressed large deformation of the membrane, with a spatial resolution of the order of a few millimeters, which is attractive for applications requiring large aberration corrections. It further affords a greater flexibility of configuration with simpler electronic control circuitry, thus allowing to strongly reduce power consumption, with benefits for the compactness and robustness of the assembly itself, both in the case of a mirror and of a lens.

The preferred domain of application of the invention is adaptive optics, and more particularly those applications needing the corrections of the distortion of the wave-fronts of an optical beam, such as when performing imaging in a turbulent medium, e.g. in astronomy and astrophysics, or the shaping of laser beams or pulses, e.g. when correcting laser beams in high power sources. The invention may also be advantageously applied in visual optics, including devices for correcting human eyesight and enhance visual acuity, or in video-surveillance systems, optical measurement systems, optical scanning systems, medical diagnostic imaging and specifically ophthalmology.

The deformable reflective/refractive assembly of the invention may also be used as a micromechanical device, where the micro-deformations of the membrane may be exploited for controlling and moving objects at the micrometric scale in micro-fluidic systems.

Naturally, while keeping the principles at the basis of the invention, the embodiments and the specific implementing features may be widely varied from what has been disclosed and shown by way of example, without departing from the scope of protection of the invention defined by the appended claims.

1. An optically controlled deformable reflective/refractive assembly, comprising:
a deformable membrane structure having a reflecting/refractive, electrically conductive surface associated with a rigid photoconductive substrate having an electrically conductive layer on one side;
electric biasing means arranged for applying a potential difference across said membrane structure; and
a controlling light source for illuminating the photoconductive substrate in correspondence of an active region,
wherein said light source is arranged for selectively illuminating the substrate by emitting at least an optical beam adapted to generate in an area of the substrate a local electrical charge density proportional to the spatial light intensity of said beam and responsible for a local deformation of the membrane structure.

2. A reflective/refractive assembly according to claim 1, including means for spatially modulating the light intensity of the optical beam illuminating the photoconductive substrate, said means for spatially modulating being interposed between the source and the substrate.

3. A reflective/refractive assembly according to claim 2, wherein said means for spatially modulating the light intensity of the optical beam illuminating the photoconductive substrate include a liquid crystal screen, driven by a control unit adapted to switch the state of each pixel of the screen.

4. A reflective/refractive assembly according to claim 1, wherein said controlling light source comprises a point-like source and associated collimating optics.

5. A reflective/refractive assembly according to claim 1, wherein said deformable membrane structure includes an elastically deformable membrane, said membrane and the electrically conductive layer of the substrate being adapted to form the plates of a capacitor configuration, wherein potential difference applied between said plates and the generated electrical charge density causes the membrane to be attracted towards the substrate by electrostatic force.

6. A reflective/refractive assembly according to claim 5, wherein the membrane is suspended at a predetermined distance from the substrate by means of the interposition of perimeter spacing means acting as, or backing a rigid frame for the membrane, to form a free space between the membrane and the substrate transversely delimited by said spacing means, which is adapted to receive said membrane in a deformed condition.

7. A reflective/refractive assembly according to claim 6, wherein the membrane is shaped as a disc supported by a rigid annular frame suspended on the substrate by means of a ring spacer, so that the active region capable of undergoing deformation is limited by the boundary of the membrane.

8. A reflective/refractive assembly according to claim 6, wherein the membrane comprises a nitrocellulose layer, metalized by a silver coating, mounted on an Aluminum frame.

9. A reflective/refractive assembly according to claim 6, wherein the distance between the membrane and the substrate comprises between 20 and 200 μm, and preferably between 50 and 120 μm.

10. A reflective/refractive assembly according to claim 1, wherein said deformable membrane structure includes a piezoelectric plate with a front side coupled to said reflecting/refractive surface, the potential difference applied between the front side of the piezoelectric plate and the electrically conductive layer of the photoconductive substrate and the generated electrical charge density causes the plate to radially expand or contract, thereby hollowing or bulging the reflecting/refractive surface.

11. A reflective/refractive assembly according to claim 10, wherein said deformable structure includes a passive support layer coupled to a front side of said piezoelectric plate and carrying said electrically conductive surface.

12. A reflective/refractive assembly according to claim 1, wherein said deformable membrane structure includes an electro-active elastomeric membrane with a front side coupled to said reflecting/refractive surface, a potential difference applied between the electrically conductive surface of the membrane and the electrically conductive layer of the photoconductive substrate and the generated electrical charge density causes the membrane to radially expand or contract, thereby hollowing or bulging the reflecting/refractive surface.

13. A reflective/refractive assembly according to claim 1, wherein the photoconductive substrate comprises a photorefractive Bi₁₂SiO₂₀ (BSO) crystal coated on one side with a electrically conductive layer of Indium-Tin-Oxide (ITO) transparent in the visible range.
